(19) United States
(12) Patent Application Publication
(10) Pub. No.: US 2021/0392975 A1
(43) Pub. Date: Dec. 23, 2021

(54) Reusable Face Mask Supporting a Disposable Filter Cartridge Therein and Sterilizing Case for the Face Mask

(71) Applicants: William Turk, Winnipeg (CA); Christian Petropolis, Winnipeg (CA)

(72) Inventors: William Turk, Winnipeg (CA); Christian Petropolis, Winnipeg (CA)

(21) Appl. No.: 17/227,654

(22) Filed: Apr. 12, 2021

Related U.S. Application Data
(60) Provisional application No. 63/042,658, filed on Jun. 23, 2020.

(51) Int. Cl. A41D 13/11

(52) U.S. Cl. CPC A41D 13/1192; A41D 13/1107

(57) ABSTRACT

A face mask for filtering air has a mask body for extending over a nose and mouth area of a user. The mask body and integrally joined supporting straps are formed of an elastomeric material that is unitary in structure so as to be continuous and seamless throughout. The elastomeric material has physical properties that provide shape retention and elasticity such that the peripheral edge of the mask conforms and seals to a face of the user while the mask spans over the nose and mouth area of the user. A disposable filter cartridge is releasable mounted within a filter opening in the mask body. Upon removal of the filter cartridge, the remaining mask body and straps are devoid of any crevices inaccessible to a finger whereby all surfaces of the mask body are accessible for wiping with the finger. An optional sterilization case receives the mask therein for sterilization.

This application claims the benefit under 35 U.S.C.119(e) of U.S. provisional application Ser. No. 63/042,658, filed Jun. 23, 2020.

### FIELD OF THE INVENTION

The present invention relates to a face mask for being worn on the face of a user for filtering air being inhaled by the user, and more particularly the present invention relates to a face mask including a mask body formed of elastomeric material and a filter cartridge releasably mounted within the mask body in which the filter cartridge is disposable and the mask body can be sterilized, for example in a portable sterilization case, for reuse of the mask body.

### BACKGROUND

Respirators currently exist in two main forms: industrial respirators and surgical mask respirators. These relate to different contexts: (i) protection from industrial and environmental exposure and (ii) protection from infection and biologic exposure (e.g. viruses including coronavirus, bacteria, blood splatter, etc.).

Industrial respirators are designed to be reused in the context of protection from industrial and environmental exposure. They have some limitations in that context. They are generally not designed to be reused in a surgical and medical context.

Surgical respirators are designed to be used within a surgical context. Generally surgical respirators are not designed to be re-used and/or decontaminated. They are disposable, one-time use devices.

### SUMMARY OF THE INVENTION

According to one aspect of the invention there is provided a face mask apparatus for filtering air comprising:

a mask body comprising a central portion arranged to extend over a nose and mouth area of a user and a peripheral edge surrounding the central portion;

the mask body being formed of an elastomeric material that is unitary in structure so as to be continuous and seamless throughout the mask body;

the elastomeric material having physical properties that provide shape retention and elasticity such that the peripheral edge of the mask conforms and seals to a face of the user while the central portion spans over the nose and mouth area of the user;

at least one filter opening formed in the central portion of the mask body;

at least one strap arranged to secure the mask body to the face of the user;

a filter cartridge associated with said at least one filter opening comprising (i) a filter housing formed of rigid material defining a flow passage through the filter cartridge between an outer opening and an inner opening of the filter housing and (ii) a filter medium spanning across the flow passage between the outer opening and the inner opening in which the filter cartridge is releasably mounted within the filter opening in the mask body such that the inner opening and the outer opening communicate with opposing sides of the mask body;

the mask body and said at least one strap, upon removal of the filter cartridge, being devoid of any crevices or openings that are inaccessible to a finger of a user by elastic deformation thereof whereby all surfaces of the mask body are accessible for wiping with the finger of the user.

By removing the filter cartridge and forming the mask body to be devoid of openings or crevices that are inaccessible to a finger by stretching or deforming the mask body, the entire surface of the mask body can be wiped with a suitable sterilizing solution to allow reuse of the mask body in a surgical or medical environment.

The filter housing may be supported within the filter opening by stretching the elastomeric material about the filter housing, wherein a minimum diameter of the filter opening in the elastomeric material of the mask body in a relaxed state is smaller than a corresponding diameter about the filter housing such that the elastomeric material is supported under tension circumferentially about the filter housing, whereby direct contact of the filter housing with the elastomeric material of the mask body is solely relied upon to support the filter housing removably relative to the elastomeric material of the mask body.

The filter opening in the mask body may be surrounded by an annular rib formed of the elastomeric material and defining a minimum inner diameter of the filter opening, in which the filter housing includes a mounting collar portion having an annular groove formed therein which receives the annular rib therein in a mounted position of the filter cartridge on the mask body, and in which the mounting collar increases in diameter about a full circumference thereof at axially opposing sides of the annular groove so as to be arranged for abutment against axially opposing end faces of the annular rib in the mounted position.

The apparatus may include a liner comprising an absorptive material spanning an inner surface of the central portion of the mask body without covering said at least one filter opening or the peripheral edge of the mask body, in which the liner is readily removable from the mask body.

The at least one strap may be formed of said elastomeric material integrally with the mask body so as to be continuous and seamless with the mask body and so as to be devoid of any crevices or openings between said at least one strap and the mask body that are inaccessible to a finger by elastic deformation of the elastomeric material.

The apparatus may further include a clip member including a pair of retainer slots therein receiving respective strap portions of said at least one strap therein such that each strap portion is removable from an open end of the respective retainer slot, in which each retainer slot has a dimension between opposing side edges of the retainer slot which is less than a corresponding dimension of the strap portion received therein such that the strap portion is frictionally retained in fixed relation to the retainer slot, whereby a loop of the strap portion can be isolated from a remainder of the strap portion to adjust an effective length of the remainder of the strap portion between the clip member and the mask body.

The flow passage of the filter cartridge may be arranged to diverge outwardly with increasing diameter from inner opening to the outer opening of the filter cartridge.

The elastomeric material of the mask body may consist of silicone, or another similar elastomeric material that is preferably heat resistant up to at least 200 degrees Celsius. The elastomeric material preferably has a durometer of between 00-30 to 40A. In this instance, the mask body may have a thickness between an inner surface and an outer surface that is between 1 mm and 8 mm.

The mask body may further comprise a peripheral flange extending inwardly from the peripheral edge about a full perimeter mask body along an inner side of the central portion for sealing engagement with the face of the user, in which the peripheral flange is formed of the elastomeric material integrally with the central portion so as to be joined seamlessly with one another, and in which the peripheral flange is resiliently foldable relative to the mask body such that any crevice between the peripheral flange and the inner side of the central portion is readily accessible by a finger of the user. The peripheral flange may be tapered inwardly so as to be reduced in thickness from the perimeter edge of the mask body to an inner free end of the peripheral flange about a full perimeter of the mask body.

The at least one filter opening is preferably the only opening in the mask body. A minimum diameter of the flow passage of said at least one filter opening may be at least 2.5 centimeters, and is preferably at least 3 centimeters so as to be sized to readily allow both inhalation and exhalation therethrough.

When the filter opening is the only opening in the mask body, the filter cartridge may include (i) an exhaust passage communicating through the filter cartridge in parallel with the flow passage and (ii) an exhaust valve operatively connected to the exhaust passage so as to only allow outward flow to an exterior of the mask body through the exhaust passage.

Described herein is a mask, tensioner clips, filter and optional carrying/cleaning case for a re-usable/cleanable respirator that both meets needs of industrial use and particularly medical and surgical use.

The respirator unit (mask and filter) is designed to meet or exceed the ASTM F2100-19 Standard Specification for Performance of Materials Used in Medical Face Masks Level 1, 2, and 3.

The most relevant specifications relate to: (i) Bacterial Filtration Efficiency (>95% for level 1, >98 for level 2 and 3); (ii) Differential Pressure (<5 mm H20/cm2 for level 1, <6 mm H20/cm2 for level 2 and 3); (iii) Submicron particulate filtration efficiency at 0.1 and 0.3 micron level (>95% for level 1, >98% for level 2 and 3; and (iv) Resistance to penetration by synthetic blood (with minimum pressure in mm Hg of 80 for level 1, 120 for level 2, 160 for level 3).

The respirator unit is also designed to meet or exceed NIOSH certification, particularly for 42 CFR Part 84 Respiratory Protective Devices.

Filtering material might include (but is not limited to) one which meets reference test TEB-APR-STP-0059 which is for determining particulate filter efficiency for N95 series filters in non-powered, air-purifying respirators.

The fact that it meets or exceeds the two standards of both ASTM testing and NIOSH testing, given it is reusable/cleanable by a variety of techniques, makes this a unique and innovative respirator.

According to another aspect of the present invention there is provided a portable sterilization case for use with a reusable face mask apparatus, the face mask apparatus comprising a mask body formed of elastomeric material comprising a central portion arranged to extend over a nose and mouth area of a user and a peripheral edge surrounding the central portion to conform and seal to a face of the user, a filter opening formed in the central portion of the mask body, and a filter cartridge comprising a filter housing formed of rigid material defining a flow passage therethrough and a filter medium spanning across the flow passage in which the filter cartridge is releasably mounted within the filter opening in the mask body, the sterilization case comprising:

a receptacle portion having a hollow interior sized to receive the mask body of the face mask apparatus therein and an access opening through which the mask body can be inserted into the receptacle portion;

a lid movable relative to the receptacle portion between a closed position spanning across the access opening such that the mask body is fully enclosed within the receptacle portion and an open position in which the access opening is substantially unobstructed by the lid; and

a sterilization device operatively connected to the receptacle portion so as to be arranged to sterilize the mask body while the mask body is enclosed within the receptacle portion in the closed position of the lid.

By providing a portable case, for example sized to receive a single mask body therein, together with a sterilization device incorporated therein, the mask body can be repeatedly sterilized by the user of the mask on demand as required. For example, a doctor can readily sterilize the mask body for reuse between medical interactions with two different patients.

The sterilization device may comprise a water reservoir in communication with the hollow interior of the receptacle portion in which the receptacle portion and sterilization device are microwavable so as to generate steam for sterilizing the mask body within the receptacle portion.

The sterilization device may alternatively comprise a water reservoir in communication with the hollow interior of the receptacle portion and a heater in communication with the water reservoir so as to generate steam for sterilizing the mask body within the receptacle portion.

The sterilization device may yet further comprise an ultraviolet light source within the hollow interior of the receptacle portion so as to be arranged to radiate ultraviolet light upon the face mask apparatus for sterilizing the mask body within the receptacle portion.

Alternatively, the sterilization device may comprise a pump arranged to circulate a sterilizing fluid through the hollow interior of the receptacle for sterilizing the mask body within the receptacle portion.

The hollow interior of the receptacle portion may be sized to receive only a single mask body therein at one time.

According to a further aspect of the present invention there is provided a mask fitting apparatus for use with a filtration mask having a filter body formed of a filtration material for covering a nose and mouth of a user, the apparatus comprising:

an annular flange body surrounding a central opening, the annular flange body being sized to overlap an exterior of the filter body of the filtration mask in proximity to a perimeter edge of the filter body about a full perimeter of the filter body such that a majority of the filtration body remains exposed by the central opening in the annular flange body; and

a pair of straps connected to the annular flange body and arranged to extend about a head of the user under tension such that the annular flange body applies an inward pressure onto the filter body about the full perimeter of the filter body;

wherein a perimeter shape of the central opening includes V-shaped portion tapering towards an upper apex for alignment with a bridge of the nose of the user.

The annular flange body and the straps may be formed seamlessly and continuously with one another of a common resilient material so as to be devoid of any crevices or openings that are inaccessible to a finger of a user whereby all surfaces of the mask body are accessible for wiping with the finger of the user.

The common resilient material may be a silicone material and/or a material that is heat resistant up to at least 200 degrees Celsius. The perimeter shape of the central opening may include an inwardly protruding convex lobe at each of the laterally opposing sides of the upper apex of the V-shaped portion for position adjacent opposing sides of the nose of the user.

The apparatus may also include one or more air pockets formed within the annular flange. Preferably the one or more air pockets are adjustable to vary a fit of the apparatus against the face of the user.

### BRIEF DESCRIPTION OF THE DRAWINGS

Some embodiments of the invention will now be described in conjunction with the accompanying drawings in which:

FIG. 1 is a front elevational view of a first embodiment of the face mask apparatus;

FIG. 2 is a rear elevational view of the face mask apparatus according to the first embodiment of FIG. 1;

FIG. 3 is a side elevational view of the face mask apparatus according to the first embodiment of FIG. 1;

FIG. 4 is a sectional view of the mask body of the face mask apparatus according to the first embodiment of FIG. 1;

FIG. 5 is a front elevational view of the mask body according to a second embodiment of the face mask apparatus;

FIG. 6 is a rear elevational view of the face mask apparatus according to the second embodiment of FIG. 5;

FIG. 7 is a sectional view of the mask body according to the second embodiment of FIG. 5;

FIG. 8 is a sectional view of the mask body according to a third embodiment of the face mask apparatus;

FIG. 9 is a sectional view of the mask body according to a fourth embodiment of the face mask apparatus;

FIG. 10 is a sectional view of the mask body according to a further embodiment of the face mask apparatus in which a liner is provided;

FIG. 11 is a sectional view of an alternative filter cartridge for use with the face mask apparatus;

FIG. 12 is a sectional view of a mask body according to another embodiment of the face mask apparatus in which two filter cartridges are mounted on the mask body;

FIG. 13 is a perspective view of a tensioning clip for use with the straps of any of the above noted embodiments of the face mask apparatus;

FIG. 14 is a schematic representation of the clip according to FIG. 8 shown in use;

FIG. 15 is a schematic representation of the straps according to a further embodiment of the face mask apparatus;

FIG. 16 is a schematic representation of a portable case for receiving therein the mask body of the face mask apparatus according to any of the previous embodiments;

FIG. 17 is a schematic representation of a further embodiment of the portable case;

FIG. 18 is a schematic representation of a further embodiment of the portable case; and

FIG. 19 is a schematic representation of a further embodiment of the portable case;

FIG. 20 is a perspective view of a mask fitting apparatus according to a further aspect of the present invention;

FIG. 21 is a rear elevational view of the mask fitting apparatus according to FIG. 16; and

FIG. 22 is a side elevational view of the mask fitting apparatus supporting a conventional filtration mask against the face of a user.

In the drawings like characters of reference indicate corresponding parts in the different figures.

### DETAILED DESCRIPTION

Referring to the accompanying figures, there is illustrated a face mask apparatus generally indicated by reference numeral 10. The face mask apparatus 10 is particularly suited for being worn on the face of a user for filtering air breezed by the user.

The face mask apparatus 10 generally includes a mask body 12 for covering the nose and mouth area of the user, a filter cartridge 14 releasably mounted relative to a filter opening 16 in the mask body 12, and one or more straps 18 for securing the mask body on the face of the user.

Although various embodiments of the face mask apparatus are shown in the accompanying figures and described herein, the features in common with the various embodiments will first be described.

The mask body 12 comprises a unitary, single body formed of elastomeric material so as to be uniform throughout and so as to be continuous and seamless throughout. The mask body includes a central portion 20 protruding forwardly from a perimeter edge 22 which is generally triangular in shape at a rear of the mask body. An inner surface of the central portion 20 is generally concave, while the outer surface of the central portion is generally convex in shape. The central portion surrounds a central axis of the mask body extending forwardly from the rear of the mask body and in perpendicular relation to a plane at the rear of the mask body that defines the perimeter edge 22.

The triangular shape of the perimeter at the rear of the mask body is oriented such that one side edge of the triangular perimeter extends laterally across a bottom of the mask body while the other two sides of the triangular perimeter extend upwardly and inwardly to one another from the bottom to a central apex 24 at the top of the mask body. The central portion 22 extends forwardly and inwardly from the laterally opposing sides of the perimeter edge 22 to form a central ridge extending downwardly and forwardly from the upper apex 24 at the center of a bridge extending laterally over the nose area of the user.

The filter opening 16 is located at the front of the mask body and communicates axially through the mask body in the direction of the central axis of the body from the inner surface to the outer surface of the mask body, at a central location relative to the perimeter edge at the rear of the mask body.

The perimeter edge at the rear of the mask body 12 supports a perimeter sealing flange 26 thereon which extends generally radially inwardly about the full perimeter of the perimeter edge towards the central axis of the mask body. The perimeter flange 26 joins the central portion 20 to form a curved transition therebetween such that a rear surface of the perimeter flange for abutment with the face of the user is generally convex in profile. The perimeter flange 26 continues to extend inwardly from the rearmost convex portion of the perimeter flange at a forward slope so as to approximately follow the shape of the inner surface of the central portion 20 of the mask body about the full perimeter thereof while remaining spaced slightly apart from the inner surface of the central portion 20. The perimeter flange 26 may span a radial distance of between approximately 1 and 3 centimeters, but preferably near 2 centimeters, from the perimeter edge of the central portion 20 to an inner free edge of the perimeter flange which is located forwardly of the rear plane of the mask body. The perimeter flange 26 is elastically flexible and foldable relative to the central portion 20 such that the perimeter flange can be flexed rearwardly and unfolded relative to the inner surface of the central portion for readily accessing any crevice between the perimeter flange and the central portion 20 with fingers of the user for wiping of the surfaces during sterilization.

An overall thickness of the elastomeric material of the mask body between the inner surface and outer surface thereof is preferably between 1 and 8 mm. A durometer of the material is selected to provide suitable shape retention at the selected thickness while remaining readily flexible to conform to the shape of the face of the user and to allow any crevices or openings in the mask body to be readily accessed by a finger of the user for wiping during sterilization by stretching and inelastic the formation of the elastomeric material of the mask body. The durometer range for silicone is between shore hardness 00-30 to 40A. The perimeter flange has a thickness which is tapered to be reduced in thickness in a radially inward direction from the outer end of the flange that is joined to the perimeter edge of the central portion 20 to the inner free edge of the flange.

The forwardmost apex of the central portion 20 of the mask body defines a mounting portion in which the material between the inner and outer surfaces of the mask body is thicker than the remainder of the mask body while locating the filter opening 16 centrally therein. The filter opening 16 is shaped to define a central axis of the opening which is parallel to the central axis of the mask body and perpendicular to a plane locating the perimeter flange 26 at the rear side of the mask body.

The filter opening 16 is sized such that a minimum inner diameter of the filter opening is less than a corresponding diameter of a portion of the filter cartridge 14 received therein. In this manner the material of the mask body must be resiliently and elastically stretched or deformed so as to be under tension in a circumferential direction about the portion of the filter cartridge received within the filter opening. The direct engagement of the elastomeric material of the mask body with the filter cartridge and the required stretching of the elastomeric material about the filter cartridge provide sufficient frictional forces to retain the filter cartridge mounted within the mask body with an airtight seal therebetween, while permitting the filter cartridge to be readily removed from the mask body for disposal after use by simple elastomeric deformation of the mask body 12.

In the preferred embodiment, the elastomeric material is silicone having a high temperature resistance exceeding 200 degrees Celsius before degradation, and a durometer between 00-30 to 40A that provides shape retention and elasticity such that the peripheral edge of the mask conforms and seals to a face of the user with the central portion spanning over the nose and mouth area. All surfaces of the elastomeric material are smooth with closed cells to allow for ready sanitation of the surfaces, for example by wiping with a sanitizing fluid.

The straps 18 are typically formed of the same elastomeric material as the mask body 12 regardless of whether the straps are formed integrally together with the mask body or as separate components. The elastomeric material has a high degree of elasticity to accommodate a large range of sizes for fitting on a large number of users even when the straps are suited for extending fully about the cranium of the user. The straps 18 in the illustrated embodiment are formed as a flat band having smooth surfaces with closed cells so to be readily wipeable with a sanitizing fluid for sanitizing.

The straps 18 and the mask body 12 are collectively devoid of any crevices or openings that cannot be accessed by a finger of the user for wiping when the elastomeric material is elastically stretched or deformed by the user. Accordingly any openings in either of the straps or the mask can be accessed by stretching for insertion of a finger to wipe all surfaces.

A clip member 28 is optionally provided to further accommodate a variety of different sizes of the straps. One clip member 28 is associated with each strap when two straps are provided in accordance with the illustrated embodiment. More particularly the straps include an upper strap connected between laterally opposing sides of the mask body in proximity to the apex at the top end of the mask body and a lower strap connected between laterally opposing sides of the mask body in proximity to the bottom end of the mask body.

Each clip member is formed of a rigid plastic material as a flat body including two retainer slots 30 extending inwardly from an open end at a common side of the clip member body. The retainer slots 30 are elongated in shape so as to have a narrow width between opposing side edges of the slot which is much smaller than the thickness of the straps, for example less than half the thickness thereof. In use, a portion of each strap is elastically compressed to permit insertion into each of the retainer slots 30 such that the elastic compression of the strap portion within each slot provides sufficient frictional forces to retain the clip member at a mounted location along each strap portion. Each slot 30 may further follow a bent path as illustrated to further resist removal of the strap portion from slot in use. The clip member thus serves to isolate a loop of the strap from the remainder of the strap such that an effective length of the strap between the mask body and the clip member 28 can be adjusted for accommodating different sizes of craniums received within the strap in a working position.

The clip member 28 can be readily separated from the strap. Once separated, the strap and the clip member each have smooth surfaces devoid of any crevices so as to be readily accessible by wiping for sanitation with a suitable sanitizing fluid. The clip member is formed of a rigid plastic material which resists degradation from sanitizing fluids. The inner edges of the narrow retainer slots 30 can be readily wiped bypassing of a flexible cloth into each slot once separated from the strap.

The filter cartridge 14 includes a filter housing 32 formed of a rigid material, for example plastic material which is moulded to form the outer structure of the filter cartridge. A flow passage 34 is defined extending through the housing in communication between an inner opening 36 at an inner side of the filter cartridge in the mounted position on the mask body and an outer opening 38 at an outer side of the filter cartridge in the mounted position on the mask body. A filtration medium 40, for example one or multiple layers of filtering material, are supported within the filter housing 32 so as to fully span across the flow passage 34 such that flow through the filter cartridge from the outer opening 38 to the inner opening 36 must pass through the filtration medium for filtering.

An inner end of the filter cartridge comprises a mounting collar portion 42 which is the portion of the filter housing arranged to be received within the filter opening in the mask body in the mounted position. The mounting collar portion 42 is generally annular about the inner opening 36 at the inner end of the filter cartridge.

A portable case 44 is optionally provided with the face mask apparatus 10 to receive at least the mask body 12 and the straps 18 therein when the filter cartridge 14 is removed from the mask body. The portable case 44 typically includes a receptacle portion 46 having rigid walls surrounding a hollow interior which is suitably sized to receive only a single mask body and the associated straps 18 thereof within the hollow interior. An access opening is provided within the receptacle portion through which the mask body and straps can be inserted into and removed from the hollow interior of the receptacle portion. A lid 48 is operable relative to the access opening of the receptacle portion between a closed position spanning across the access opening and an open position in which the access opening is substantially unobstructed by the lid. The access opening is typically the only opening provided in the receptacle portion such that the mask body and straps are fully enclosed within the hollow interior of the receptacle portion in the closed position of the lid 48.

A sterilization device 50 is supported on the receptacle portion in open communication with the hollow interior thereof such that operation of the sterilization device sterilizes the surfaces of the mask body and straps received within the portable case.

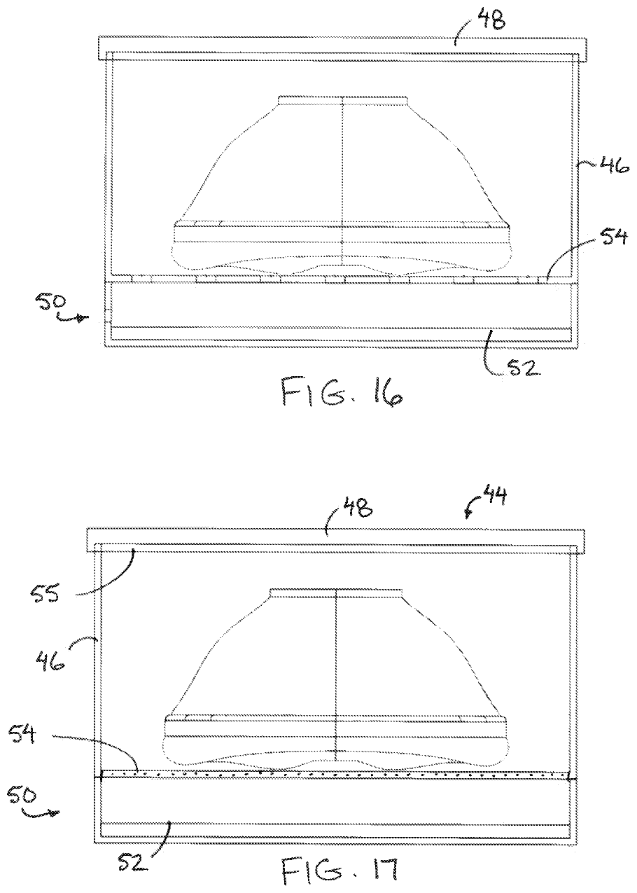

With reference to the embodiment of FIG. 16, the sterilization device 50 in this instance comprises a water reservoir 52 joined to the portable case for communication of water within the reservoir with the hollow interior of the receptacle portion through a semi-porous barrier 54 forming a floor of the receptacle portion. The components of the portable case 44 and the reservoir in this instance may be safe for microwaving such that a microwave can be used to sufficiently heat the water and convert some of the water within the reservoir to steam that passes through the semi-porous barrier 54 for circulation within the hollow interior of the receptacle portion to sterilize the contents thereof.

With reference to the embodiment of FIG. 17, in this instance a water reservoir 52 is again joined to the portable case for communication of water within the reservoir with the hollow interior of the receptacle portion through a semi-porous barrier 54 forming a floor of the receptacle portion. In this instance however, a heater 55 is also provided within the receptacle portion or the water reservoir to generate heat and steam within the hollow interior of the receptacle portion for sterilizing the contents thereof.

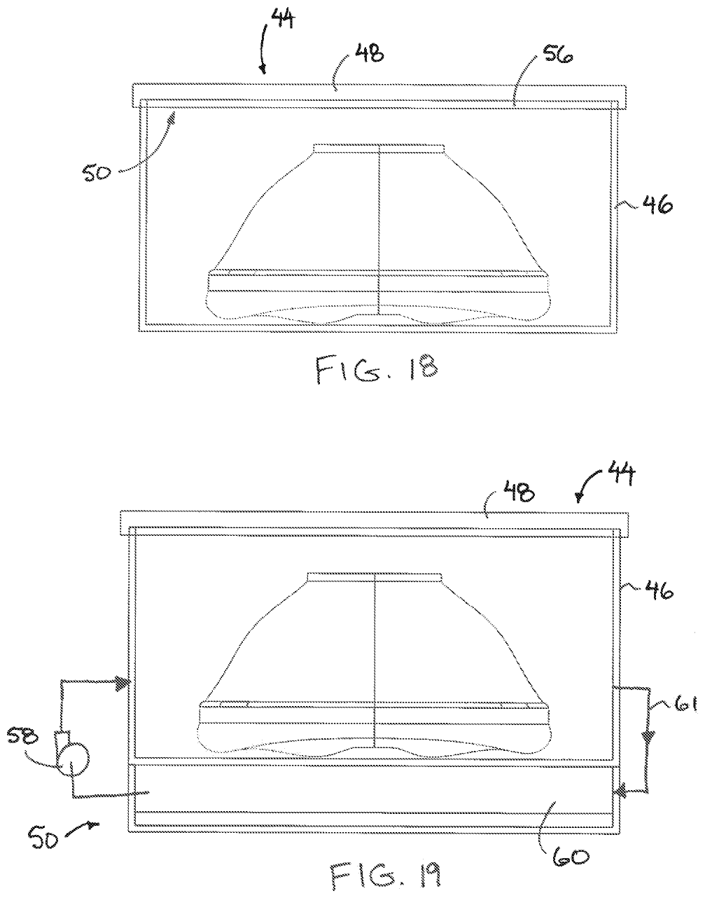

With reference to the embodiment of FIG. 18, in this instance the sterilization device may comprise an ultraviolet light source 56 mounted within the hollow interior of the receptacle portion. Activation of the ultraviolet light source together with reflective surfaces within the receptacle portion may be arranged to radiate contents of the receptacle portion with ultraviolet light from all directions to sufficiently sterilize the mask body within the receptacle portion. In some instances, the mask body may be required to be flexed into an inverted or inside-out configuration for a second treatment by the sterilization device within the portable case to sufficiently sterilize all surfaces of the contents within the receptacle portion.

Turning now to FIG. 19, in this instance the sterilization device may comprise a pump 58 in communication from a fluid reservoir 60 to the hollow interior of the receptacle portion and a return line 61 in communication from the hollow interior back to the reservoir. In this manner, the pump is arranged to circulate a sterilizing fluid from the fluid reservoir 60 through the hollow interior of the receptacle portion using the pump 58 to sufficiently sterilize the contents of the receptacle portion.

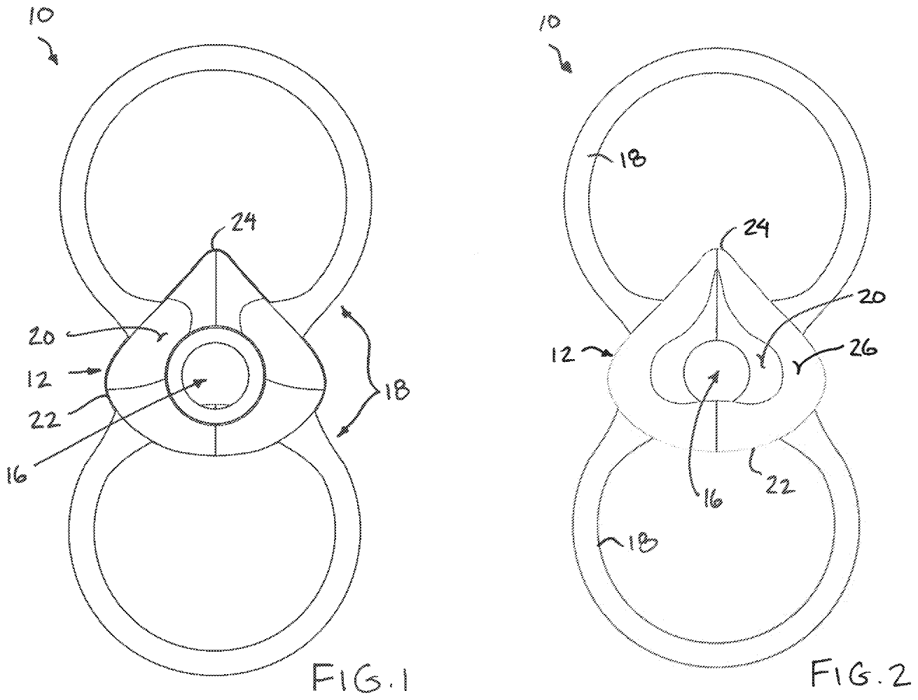

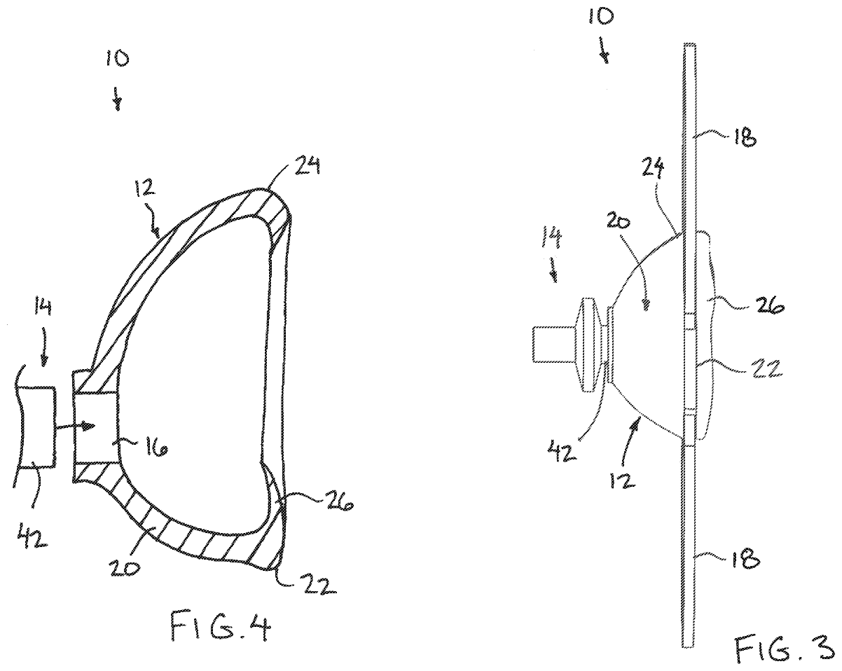

Turning now more particularly to the embodiment of FIGS. 1 through 4, the mask body in this instance may cooperate with a commercially available filtration cartridge of the type having a mounting collar portion 42 which is generally cylindrical in shape. In this instance the filtration opening through the mask body has an inner surface which is similarly cylindrical but reduced in diameter in a relaxed state relative to the mounting collar portion 42 of the filter cartridge 14. In this manner, the elastomeric material of the mask body must be stretched and elastically deformed to enlarge the circumference thereof to fit around the mounting collar portion 42 of the filter cartridge. The stretch fit serves to form an airtight seal therebetween as well as providing sufficient friction to retain the filter cartridge in a mounted position within the mask body by the direct contact of the elastomeric material of the mask body with the rigid material of the filter housing 32 of the filter cartridge.

In some embodiments, additional exhaust openings may be provided within the central portion of the mask body to receive additional filtration cartridges that are similarly mounted within the exhaust openings. The filtration cartridges of both the filter opening 16 for inhalation and the exhaust openings for exhalation are readily available disposable cartridges in this instance while the surfaces of the filter opening and the exhaust openings remain readily accessible by a finger of the user for wiping during sterilization.

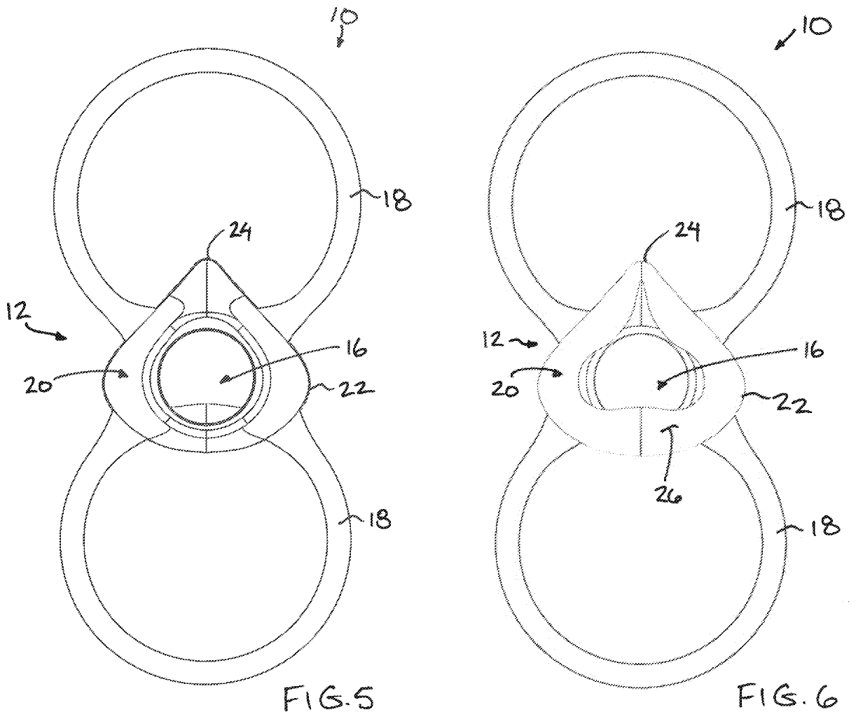

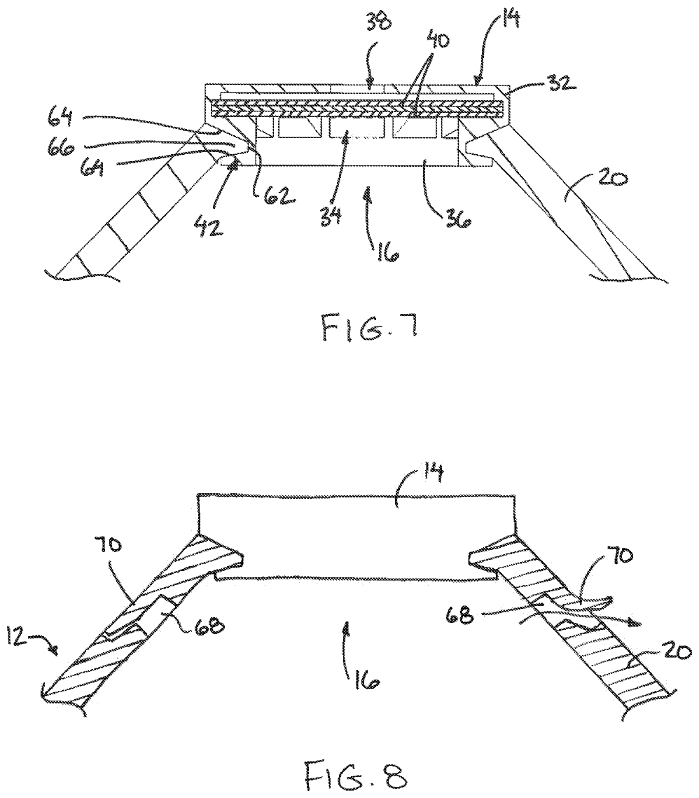

In a further embodiment according to FIGS. 5 through 7, the filter opening 16 in the mask body in this instance comprises the only opening in the mask body other than the rear opening through which the nose and mouth of the user communicate. In this instance, the flow passage through the filter cartridge and the filter opening 16 receiving the filter cartridge therein have sufficiently large diameters to allow comfortable inhalation and exhalation of the user through the same passage.

In this instance, the mounting collar portion 42 of the filter cartridge may include an annular groove 62 formed therein which is bounded at axially opposing ends by a pair of end faces 64 forming the opposing sides of the groove 62. The annular end faces 64 extend radially outward in diverging relationship to one another such that the profile of the annular groove is generally V-shaped.

The filter opening 16 in the mask body 12 in FIG. 5 has a matching shape by providing an annular rib 66 extending about the circumference of the filter opening which extends radially inwardly while tapering to be reduced in thickness in towards the inner free edge thereof. The inner diameter of the annular rib 66 is slightly less than the minimum diameter of the annular groove 62 so that some stretching of the elastomeric material of the mask body is again required for the mounting collar portion 42 of the filter cartridge to be received within the filter opening in the mask body. The tapering profile of the axially opposed annular end faces of the rib 66 follow the shape of the end faces 64 of the mounting collar portion of the filter cartridge for continuous abutment about the complete profile of the annular groove 62 between the mounting collar portion of the filter cartridge and the mask body. The annular rib 66 may be slightly thicker in the axial direction than the annular groove to require some axial compression of the elastomeric material of the mask body being received within the annular groove to improve the sealing relationship therebetween and the frictional forces retaining the filter cartridge mounted within the mask body.

In the embodiment of FIG. 5, a set of three layers of filtration medium are provided which fully span across the flow passage as described in further detail below.

Turning now to the embodiment of FIG. 8, the filtration cartridge in this instance is substantially identical to the embodiment of FIG. 5; however, in this instance additional exhaust ports 68 are formed in the central portion of the mask body independently of the filter opening 16. More particularly, two exhaust ports 68 are shown in the illustrated example at laterally opposing sides of the filter opening 16. Each exhaust port is associated with a flap valve 70 operatively connected thereto in which the flap valve 70 is formed integrally, continuously and seamlessly with the elastomeric material of the mask body. The flap valve 70 comprises a flexible panel of the elastomeric material which is biased into a closed position spanning across the respective exhaust port 70 to close the port. In response to increased pressure within the interior of the mask body as a result of the exhalation of the user, the flap valves 70 will be urged to open to allow the exhausting of air from the mask body therethrough. The flap valves are anchored on the mask body at respective forward edges so as to be opened rearwardly and laterally outwardly in opposing directions from one another during exhalation. The exhaust ports 68 and the flap valves 70 are elastically deformable and foldable relative to the mask body so as to allow access to all surfaces thereof for wiping by a finger of the user during sterilization.

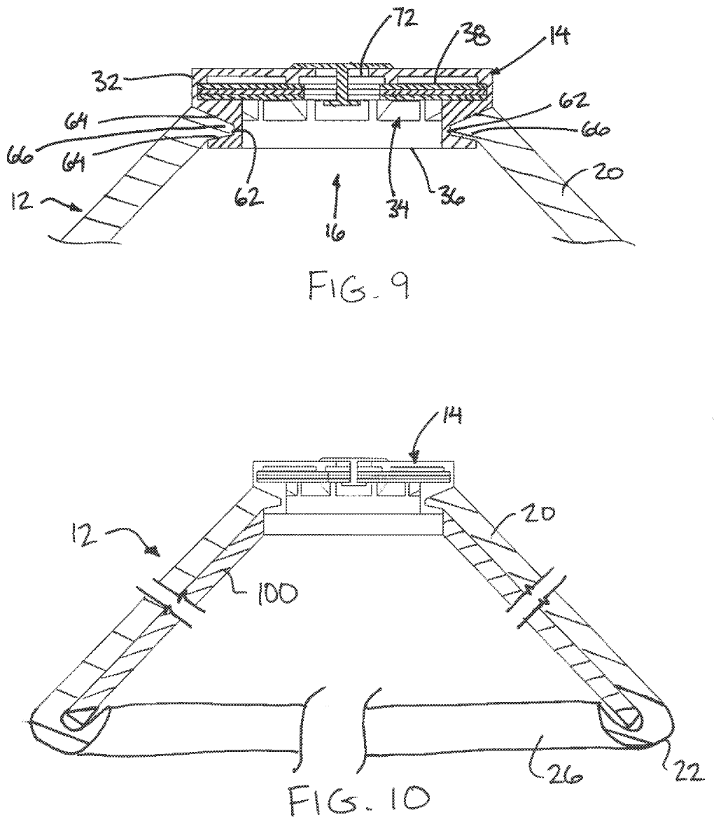

Turning now to the embodiment of FIG. 9, in this instance the filter cartridge is modified to include an exhaust passage 72 formed within the filter housing in parallel with the flow passage through the housing. More particularly, in the illustrated embodiment a single exhaust passage 72 is centrally located within the filter cartridge for communication between the inner opening 36 and the outer opening 38 thereof while a plurality of individual inhalation ports 73 communicate through the filter housing to commonly define the flow passage 34 at circumferentially spaced apart positions surrounding the central exhaust passage 72. A check valve 74 is operatively associated with the exhaust passage to only allow flow externally of the mask body by biasing the valve closed until exhalation pressure within the mask opens the valve to allow air to be exhausted through the exhaust passage. During inhalation, the valve 74 remains closed so that flow only passes through the inhalation ports 73. The filtration medium 40 in this instance may be annular in shape to only span across the inhalation ports 73 forming the flow passage, or alternatively one or more layers of the filtration medium may additionally span across the exhaust port 72.

Turning now to the embodiment of FIG. 10, in this instance, the mask body may be further provided with a removable liner 100. The liner is formed of an absorptive material capable of absorbing humidity, for example a paper or cloth material which is intended to be disposed of subsequent to use of the mask. The liner is arranged to collect moisture within the interior of the mask during use and thereby prevent condensation on the interior surfaces of the mask body in use. The liner is generally conical in shape to match the concave interior shape of the mask body by lining the inner surface of the central portion 20 of the mask body. The liner includes an opening therein in alignment with the one or more filter openings 16 in the mask body respectively so as not to interfere with airflow through the flow passage of a cartridge within the filter opening. The perimeter edge of the liner 100 may be located in close proximity to the perimeter edge 22 of the mask body in a manner which does not interfere with the engagement of the perimeter edge 22 or the perimeter sealing flange 26 at the perimeter edge the face of the user. More particularly, the liner can be inserted between the inner surface of the central portion 20 of the mask body and the perimeter sealing flange 26 such that the perimeter sealing flange overlaps the perimeter edge of the liner 100 to assist in locating and retaining the liner within the interior of the mask body. The liner is readily flexible and pliable to permit insertion into the mask body while the flexibility of the perimeter sealing flange permits the sealing flange to be reoriented in overlapping arrangement with the perimeter edge of the liner. Subsequent to use of the mask, the liner is disposed of and the mask body is sterilized so that a new sterile liner can be inserted into the sterilized mask body for reuse of the mask.

Turning now to FIG. 11, a further embodiment of the filter cartridge 14 is illustrated which can be used with any of the embodiments of the mask body 12 described herein. The filter cartridge in this instance differs from the previous embodiments in that the flow passage 34 extending through the housing 32 of the filter cartridge from the inner opening 36 at the inner end to the outer opening 38 at the outer end generally diverges in shape and size with increasing diameter towards the exterior of the cartridge. A filtration medium 40 is again mounted to fully span across the flow passage 34 so that airflow must pass through the filtration medium. The inner end of the housing 32 in this instance again comprises a mounting collar 42 with an annular groove 62 formed therein with axially opposed end faces 64 for mating connection with the annular rib 66 formed on the mask body 12 about the perimeter of the filter opening 16 as described above. The minimum internal diameter of the flow passage 34 at the inner end of the housing 32 is typically at least 2.5 cm in diameter but is preferably greater than 3 cm in diameter to ensure adequate airflow through the flow passage. The cross-sectional area of the flow passage, together with the shape, function together to optimize sound and voice transmission. In particular the short conical shape of the housing of the filter cartridge helps prevent standing cones and decreases interference patterns which otherwise muffle the voice of the user of the mask.

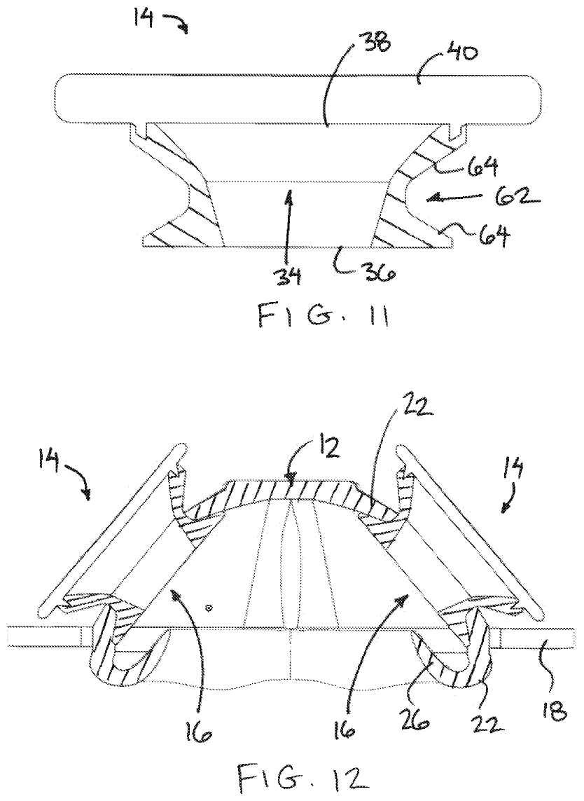

Turning now to FIG. 12, the mask body in this instance includes two filter openings 16 at laterally opposing sides of the mask body rather than a singular filter opening centrally located in the mask body. Each filter opening 16 locates a filter cartridge 14 therein in a manner which is substantially identical to the mounting of the other filter cartridges within respective filter openings as described above. In particular, the perimeter edge about each filter opening 16 defines an annular rib 66 which is received within the corresponding annular groove 62 within the mounting collar at the inner end of the filter cartridge housing as described above. When a liner 100 is provided, the liner includes openings therein which align with each of the filter openings similarly to the previous embodiments.

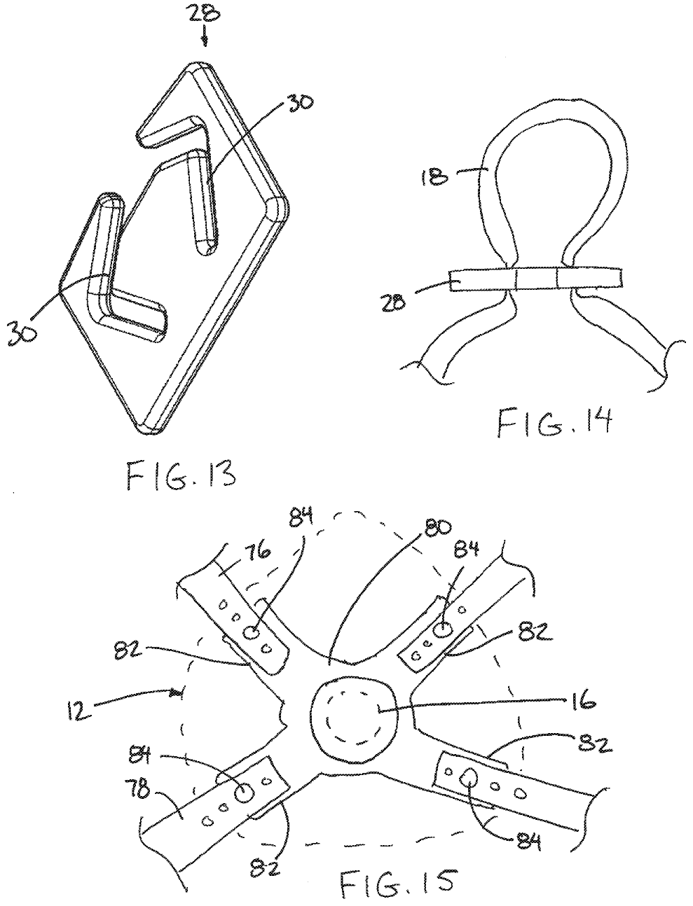

Turning now to FIGS. 1 through 14, the straps 18 in this instance may be integrally formed with the mask body such that the straps and the mask body are continuous and seamless with one another as a single moulded structure of unitary material throughout. All surfaces of the straps and the mask body and the junction therebetween are smooth, closed cell surfaces devoid of any crevices or openings therein which cannot be accessed by a finger of the user for wiping during sterilization.

Turning now to an alternative embodiment shown in FIG. 15, the straps 18 in this instance may be separable from the mask body. Preferably the straps again include an upper strap 76 connected between laterally opposing sides of the mask body in proximity to the apex at the top end of the mask body and a lower strap 78 connected between laterally opposing sides of the mask body in proximity to the bottom end of the mask body.

The straps can be supported relative to the mask body using a mask mounting frame 80 in this instance. The mask mounting frame 80 is a rigid frame arranged for abutment against the outer side of the mask body while remaining readily separable from the mask body. The rigid frame has a central opening therein for alignment with the filter opening in the mask body to receive the filter cartridge therethrough while being shaped to follow the convex profile at the exterior of the mask body. The rigid frame forming the mask mounting frame 80 also includes a set of four legs 82 extending radially outward from the central opening to define two upper legs extending in laterally opposing directions from the top end of the rigid frame and two lower legs extending in laterally opposing directions from the bottom end of the rigid frame.

Opposing ends of the upper strap include mounting apertures formed therein to be releasably secured onto mounting posts 84 on the two upper legs respectively. Similarly opposing ends of the lower strap include mounting apertures formed therein to be releasably secured onto mounting posts 84 on the two lower legs respectively. A row of mounting apertures in each strap allow the straps to be secured at different effective lengths to better accommodate different sizes of craniums about which the straps are to extend in a working position mounted onto the head of a user.

For sterilization, the straps can be separated from the rigid frame of the mask mounting frame 80 which in turn is readily separated from the mask body as the mask mounting portion merely abuts the mask body in a working position thereof. Once separated, all surfaces of the straps including the apertures can be accessed by a finger of the user for wiping by stretching of the elastomeric material forming the straps. Additionally, all surfaces of the mask mounting frame 80 comprise smooth, closed cell surfaces which are readily accessible by a wiping cloth for complete sterilization thereof by wiping if desired.

As described above, the face mask apparatus 10 includes a mask, tensioner clips, a filter and carrying/cleaning case for a re-usable/cleanable respirator that both meets needs of industrial use and particularly medical and surgical use.

The mask is an elastomeric mask (made of but not limited to silicone) with the following features: (i) robust seal between flange and face of wearer in which the seal is maintained on a wide number of user faces with variable sizes and feature proportions unlike current masks which have more limited ranges as demonstrated by respirator fit testing; (ii) silicone (or other elastomeric materials) are very comfortable on the face unlike current disposable masks which can induce pressure sores with prolonged use; (iii) a robust/tight seal between mask and filter (as opposed to other options such as a threaded mechanism) in which the seal can be formed with wide variety of currently existing filters, as well as filters newly invented.

The straps can be fully integrated or non-integrated straps also made of an elastomeric material (which allow for all the cleaning of the mask documented below). The silicone/elastomeric straps have properties of being elastic and thus can extend the range of fitting on a number of different head sizes. The elastomeric straps secure the mask to the cranium and avoid the ears. This is a significant advantage as most current masks use the ears to anchor themselves which becomes uncomfortable with prolonged use. The mask is thus easy to don and doff (take on and off) given the elastomeric properties of the straps. The straps can cooperate with tensioner clips supplied with the mask that allow for adjustable sizes of straps to allow to extend range of fitting on different head sizes. Tensioner clips can also be made from a variety of different materials which are also cleanable by all techniques documented below.

All surfaces are accessible for wiping/cleaning with disinfectant wipes (including but not limited to alcohol wipes, peroxide wipes, bleach wipes). The mask is cleanable via industrial/medical reprocessing including autoclave and chemical based systems (peroxide and ethylene oxide). The mask is also cleanable by domestic cleaning methods (that are demonstrable to clean viruses such as coronavirus 19) including dilute bleach protocols, dishwasher, steam sterilization, and pasteurization (see mask cleaning box below).

The tensioner clips are designed to allow for adjustable straps. As noted above this allows for the mask with a particular strap size to be worn on a wider range of users with variable head/cranium sizes. The tensioner clips work by friction fitting with the silicone straps and thus locking-in a particular strap tension that is adjustable for each user. Since the edge of the tensioner is smooth, it does not damage the elastomeric material. The clips stay in place even after donning and doffing. The clips can also easily be removed and cleaned by all the same methods as the elastomeric mask, provided the appropriate type of plastic is used.

The filter cartridge is designed to directly interface with silicone/elastomeric fitting. The filter is directly gripped by said fitting in a manner to provide a secure and stable position without the need for additional securing. This offers the advantage of filter removal whilst maintaining full variety of cleaning protocols of mask. The airtight seal of the filter and mask is maintained despite repeated replacement/exchange of filter and repeated cleaning of mask. A diameter of the filter opening of the mask allows for airtight seal between mask and filter with a wide variety of sizes of mask filter designs allowing for flexibility in this regard.

An option for one filter design is a filter with the feature of multiple layers of filter material. These may include (i) an inner filter material that could include chemical filter (not necessary in medical context) or a moisture barrier/collector in a medical context. In medical context advantage of filtering COVID/pathogens the wearer might be breathing out; (ii) a middle filter material that can include (but not limited to) N95 material for filtering pathogens (such as corona virus); and (iii) an outer filter material that is similar in properties to surgical masks to filter blood splatter or other fluid exposure.

It is possible to produce a large diameter of filter with these features that also offers the advantage of low air flow resistance and decreased moisture collection obviating the need for a separate exhaust valve. A large diameter filter also provides for more audibility of the user which is critically important in a health care context of hospital ward or surgical theatre. A derivation of this would be an exhaust valve integrated into the filter. The exhaust valve could have features including covering with material documented below. Alternatively, the exhaust valve could have a hard plastic cover, or no cover.

The exhaust valve may optionally be integrated into a mask (with the option also for the exhaust valve to be integrated into the filter). The exhaust valve would have feature of full wipability/cleanability by methods documented under mask.

There is also an option for the exhaust valve to be integrated into the filter so as to be protected by a physical barrier such as surgical mask material to protect the user from blood splatter and other environmental contaminants traveling towards mask at high velocity. Another option is a hard plastic casing.

A surgical mask material exhaust valve cover would also protect patients and/or other persons simultaneously from exhaled material produced by the user such as droplets which might contain pathogens such as coronavirus.

The exhaust valve (both integrated into the mask and/or the filter) can also be directed away from other persons. In a medical/surgical context this would be directed away from patients.

Optionally, two exhaust valves may be mounted in linear sequence for further protection.

The portable cleaning and/or carrying case may accompany the mask as an option for cleaning and/or carrying the mask body.

The unique feature of the case is the ability to sterilize the mask in multiple settings. This includes on a medical ward without the need for a more complicated MDR re-processing/autoclave. It also allows for easy and convenient storage. One iteration is box that sterilizes by steam generated through heating such as microwave. Another iteration is pasteurization through heat generated by case itself. Another iteration is a case with UV generated within case for sterilization. Another iteration is case that accepts chemical cartridges for cleaning (for example hydrogen peroxide).

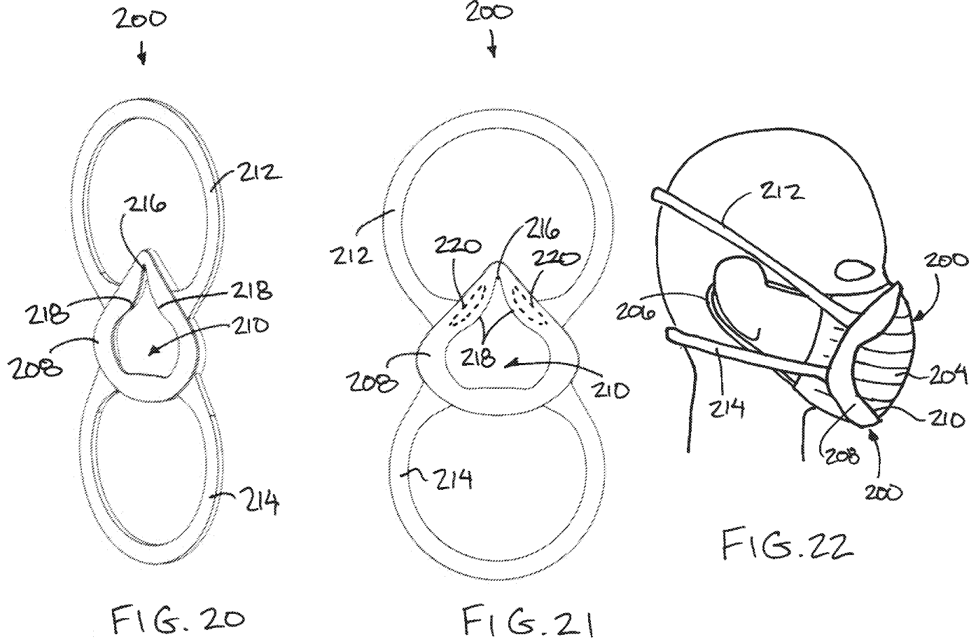

According to another aspect of the present invention, there is provided a mask fitting apparatus 200 as shown in FIGS. 20 to 22. The mask fitting apparatus 200 is intended to be used with a conventional filtration mask 202 to improve the fit of the mask against the face of the user. In the illustrated embodiment, the filtration mask 202 is a disposable mask having a filter body 204 which is domed in shape with a bridge portion for fitting over the bridge of the nose of the user such that the filter body is suitable for covering both the end of the nose and the mouth of a user. The filter body is formed of a suitable filtration material allowing air flow therethrough while restricting particles below a certain size, for example a conventional disposable N95 filtration mask. A pair of straps 206 of the filtration mask 202 are formed as loops at opposing sides of the mask body for securement about the ears of the user in a conventional manner.

The mask fitting apparatus 200 has an annular flange body 208 which is generally annular in shape having a suitable circumference so that the outer edge lies in close proximity to the perimeter edge of the mask filtration 202 when the flange body 208 lays against the exterior side of the mask body 204 in overlapping arrangement therewith about the full perimeter of the mask. A central opening 210 is provided within the flange body which is suitably sized to span a majority of the surface area of the mask body 204 such that the majority of the filtration material of the mask body 204 remains exposed by the central opening in a mounted position against the face of a user.

The apparatus 200 includes an upper strap 212 and a lower strap 214 that are each connected to the annular flange of body 208 and are each arranged for extending about the head of the user under tension so that the annular flange body applies an inward pressure onto the filter body against the face of the user about the full perimeter of the filter body. Each strap is connected at opposing ends to the laterally opposing sides of the flange body 208 such that the ends of the upper straps are connected to the flange body spaced above the ends of the lower straps respectively.

The annular flange body 208 and the straps are formed seamlessly and continuously with one another of a single common resilient material, for example a silicone which is heat resistant up to 200 degrees Celsius. The straps are joined to the annular flange body 208 such that the entirety of the surfaces of the straps and flange body collectively are devoid of any crevices or openings that are inaccessible to a finger of the user whereby all surfaces of the mask body and straps are accessible for wiping with the finger of the user for sterilization. The apparatus 200 can also be heat sterilized as an alternative to wiping.

The central opening 210 of the annular flange body 208 is shaped to have a generally teardrop shape with a V shaped portion tapering towards an upper apex 216 at the top end thereof for alignment with the bridge of the nose of the user in use. At laterally opposing sides of the upper apex 216, an inwardly protruding convex lobe 218 is formed for positioning adjacent opposing sides of the nose of the user and to ensure that the mask 202 is pressed firmly against the face of the user at opposing sides of the nose and at the recess between the nose and each cheekbone of the user.

The annular flange body 208 may further include one or more air pockets 220 formed internally therein so that the annular flange body is readily variable in shape and profile by varying the compression of air within the air pockets. The volume of air within the pockets may be varied by inflating the air pockets to vary the resulting exterior shape of the flange body 208 for improving the fit against the face of the user. Each air pocket may be a sealed envelope with a suitable valve structure in communication between the air pocket and an exterior surface of the apparatus to control the introduction of air into the air pocket for inflating or the removal of air from the pocket for deflating. A separate air pump can be externally attached to the valve, or may be incorporated into the structure of the valve to allow air to be pumped into the air pockets. The valve structure may also comprise a small dimensioned slit formed through the silicone material so that a passage can be opened for flow of air into or out of the air pocket, while relying on the resiliency of the silicone to ensure that the passage is self-closing to hold a prescribed volume of air under pressure within the air pocket once sized to fit the user. This ensures that the air pockets customize the fit of the apparatus 200 to the shape of the face of a particular user.

Since various modifications can be made in my invention as herein above described, and many apparently widely different embodiments of same made, it is intended that all matter contained in the accompanying specification shall be interpreted as illustrative only and not in a limiting sense.

1. A face mask apparatus for filtering air comprising:
a mask body comprising a central portion arranged to extend over a nose and mouth area of a user and a peripheral edge surrounding the central portion;
the mask body being formed of an elastomeric material that is unitary in structure so as to be continuous and seamless throughout the mask body;
the elastomeric material having physical properties that provide shape retention and elasticity such that the peripheral edge of the mask conforms and seals to a face of the user while the central portion spans over the nose and mouth area of the user;
at least one filter opening formed in the central portion of the mask body;
at least one strap arranged to secure the mask body to the face of the user;
a filter cartridge associated with said at least one filter opening comprising (i) a filter housing formed of rigid material defining a flow passage through the filter cartridge between an outer opening and an inner opening of the filter housing and (ii) a filter medium spanning across the flow passage between the outer opening and the inner opening in which the filter cartridge is releasably mounted within the filter opening in the mask body such that the inner opening and the outer opening communicate with opposing sides of the mask body;
the mask body and said at least one strap, upon removal of the filter cartridge, being devoid of any crevices or openings that are inaccessible to a finger of a user by elastic deformation thereof whereby all surfaces of the mask body are accessible for wiping with the finger of the user.

2. The apparatus according to claim 1 wherein the filter housing is supported within the filter opening by stretching the elastomeric material about the filter housing, wherein a minimum diameter of the filter opening in the elastomeric material of the mask body in a relaxed state is smaller than a corresponding diameter about the filter housing such that the elastomeric material is supported under tension circumferentially about the filter housing, whereby direct contact of the filter housing with the elastomeric material of the mask body is solely relied upon to support the filter housing removably relative to the elastomeric material of the mask body.

3. The apparatus according to claim 2 wherein the filter opening in the mask body is surrounded by an annular rib formed of the elastomeric material and defining a minimum inner diameter of the filter opening, and wherein the filter housing includes a mounting collar portion having an annular groove formed therein which receives the annular rib therein in a mounted position of the filter cartridge on the mask body, the mounting collar being increased in diameter about a full circumference thereof at axially opposing sides of the annular groove so as to be arranged for abutment against axially opposing end faces of the annular rib in the mounted position.

4. The apparatus according to claim 1 further comprising a liner comprising an absorptive material spanning an inner surface of the central portion of the mask body without covering said at least one filter opening or the peripheral edge of the mask body, the liner being readily removable from the mask body.

5. The apparatus according to claim 1 wherein said at least one strap is formed of said elastomeric material integrally with the mask body so as to be continuous and seamless with the mask body and so as to be devoid of any crevices or openings between said at least one strap and the mask body that are inaccessible to a finger by elastic deformation of the elastomeric material.

6. The apparatus according to claim 5 further comprising a clip member including a pair of retainer slots therein receiving respective strap portions of said at least one strap therein such that each strap portion is removable from an open end of the respective retainer slot, each retainer slot having a dimension between opposing side edges of the retainer slot which is less than a corresponding dimension of the strap portion received therein such that the strap portion is frictionally retained in fixed relation to the retainer slot, whereby a loop of the strap portion can be isolated from a remainder of the strap portion to adjust an effective length of the remainder of the strap portion between the clip member and the mask body.

7. The apparatus according to claim 1 wherein the flow passage of the filter cartridge diverges outwardly with increasing diameter from inner opening to the outer opening of the filter cartridge.

8. The apparatus according to claim 1 wherein the elastomeric material consists of silicone.

9. The apparatus according to claim 1 wherein the elastomeric material is heat resistant up to at least 200 degrees Celsius.

10. The apparatus according to claim 1 wherein the elastomeric material has a durometer of between 00-30 to 40.

11. The apparatus according to claim 1 wherein the mask body has a thickness between an inner surface and an outer surface that is between 1 mm and 8 mm.

12. The apparatus according to claim 1 wherein the mask body further comprises a peripheral flange extending inwardly from the peripheral edge about a full perimeter mask body along an inner side of the central portion for sealing engagement with the face of the user, the peripheral flange being formed of the elastomeric material integrally with the central portion so as to be joined seamlessly with one another, the peripheral flange being resiliently foldable relative to the mask body such that any crevice between the peripheral flange and the inner side of the central portion is readily accessible by a finger of the user.

13. The apparatus according to claim 1 wherein the peripheral flange is tapered inwardly so as to be reduced in thickness from the perimeter edge of the mask body to an inner free end of the peripheral flange about a full perimeter of the mask body.

14. The apparatus according to claim 1 wherein the at least one filter opening is the only opening in the mask body and wherein a minimum diameter of the flow passage is at least 2.5 centimeters so as to be sized to allow both inhalation and exhalation therethrough.

15. The apparatus according to claim 1 wherein the filter opening is the only opening in the mask body and wherein the filter cartridge includes (i) an exhaust passage communicating through the filter cartridge in parallel with the flow passage and (ii) an exhaust valve operatively connected to the exhaust passage so as to only allow outward flow to an exterior of the mask body through the exhaust passage.

16. The apparatus according to claim 1 in combination with a portable sterilization case arranged to receive the face mask apparatus therein, the sterilization case comprising:
a receptacle portion having a hollow interior sized to receive the mask body of the face mask apparatus therein and an access opening through which the mask body can be inserted into the receptacle portion;
a lid movable relative to the receptacle portion between a closed position spanning across the access opening such that the mask body is fully enclosed within the receptacle portion and an open position in which the access opening is substantially unobstructed by the lid; and
a sterilization device operatively connected to the receptacle portion so as to be arranged to sterilize the mask body while the mask body is enclosed within the receptacle portion in the closed position of the lid.

17. A portable sterilization case for use with a reusable face mask apparatus, the face mask apparatus comprising a mask body formed of elastomeric material comprising a central portion arranged to extend over a nose and mouth area of a user and a peripheral edge surrounding the central portion to conform and seal to a face of the user, a filter opening formed in the central portion of the mask body, and a filter cartridge comprising a filter housing formed of rigid material defining a flow passage there through and a filter medium spanning across the flow passage in which the filter cartridge is releasably mounted within the filter opening in the mask body, the sterilization case comprising:
a receptacle portion having a hollow interior sized to receive the mask body of the face mask apparatus therein and an access opening through which the mask body can be inserted into the receptacle portion;
a lid movable relative to the receptacle portion between a closed position spanning across the access opening such that the mask body is fully enclosed within the receptacle portion and an open position in which the access opening is substantially unobstructed by the lid; and
a sterilization device operatively connected to the receptacle portion so as to be arranged to sterilize the mask body while the mask body is enclosed within the receptacle portion in the closed position of the lid.

18. The apparatus according to claim 17 wherein the sterilization device comprises a water reservoir in communication with the hollow interior of the receptacle portion and wherein the receptacle portion and sterilization device are microwavable so as to generate steam for sterilizing the mask body within the receptacle portion.

19. The apparatus according to claim 17 wherein the sterilization device comprises a water reservoir in communication with the hollow interior of the receptacle portion and a heater in communication with the water reservoir so as to generate steam for sterilizing the mask body within the receptacle portion.

20. The apparatus according to claim 17 wherein the sterilization device comprises an ultraviolet light source within the hollow interior of the receptacle portion so as to be arranged to radiate ultraviolet light upon the face mask apparatus for sterilizing the mask body within the receptacle portion.

21. The apparatus according to claim 17 wherein the sterilization device comprises a pump arranged to circulate a sterilizing fluid through the hollow interior of the receptacle for sterilizing the mask body within the receptacle portion.

22. A mask fitting apparatus for use with a filtration mask having a filter body formed of a filtration material for covering a nose and mouth of a user, the apparatus comprising:
an annular flange body surrounding a central opening, the annular flange body being sized to overlap an exterior of the filter body of the filtration mask in proximity to a perimeter edge of the filter body about a full perimeter of the filter body such that a majority of the filtration body remains exposed by the central opening in the annular flange body; and
a pair of straps connected to the annular flange body and arranged to extend about a head of the user under tension such that the annular flange body applies an inward pressure onto the filter body about the full perimeter of the filter body;
wherein a perimeter shape of the central opening includes V-shaped portion tapering towards an upper apex for alignment with a bridge of the nose of the user.
